(19) United States
(12) Patent Application Publication
(10) Pub. No.: US 2026/0149962 A1
(43) Pub. Date: May 28, 2026

(54) INFORMATION PROCESSING APPARATUS, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yohei OGAWA, Shiojiri (JP)

(21) Appl. No.: 19/395,610

(22) Filed: Nov. 20, 2025

(30) Foreign Application Priority Data
Nov. 22, 2024 (JP) 2024-203742

(51) Int. Cl. H04W 8/22; H04W 8/00; H04W 8/18; H04W 76/10

(52) U.S. Cl. CPC H04W 8/22; H04W 8/005; H04W 8/183; H04W 76/10

(57) ABSTRACT

when a Bluetooth connection with a first device or a second device is established, determine whether the device currently connected via Bluetooth is the first device or the second device, depending on whether the device currently connected via Bluetooth is the first device or the second device, store identification information of the first device, manage the storage so that, if identification information of other first devices in a number equal to the maximum number of identification information that can be stored for the first device, the oldest identification information of the other first devices is deleted, or to store the identification information of the second device, manage the storage so that, if identification information of other second devices in a number equal to the maximum number of identification information that can be stored for the second device, the oldest identification information of the other second devices is deleted.

The present application is based on, and claims priority from JP Application Serial Number 2024-203742, filed Nov. 22, 2024, the disclosure of which is hereby incorporated by reference herein in its entirety.

### BACKGROUND

### 1. Technical Field

The present disclosure relates to an information processing apparatus, an information processing method, and a non-transitory computer-readable storage medium storing a program.

### 2. Related Art

An information processing apparatus that connects a plurality of types of electronic devices (for example, a tablet, a barcode scanner, and the like) through wireless communication has been developed. For example, JP-A-2018-5668 discloses an information processing apparatus in which the number of pieces of Bluetooth (registered trademark) pairing information that can be registered is set.

However, in a case where the information processing apparatus described in JP-A-2018-5668 performs Bluetooth pairing with a plurality of types of electronic devices, the information processing apparatus can manage only the total number of pairings for all the plurality of types of electronic devices and cannot set the number of Bluetooth pairings for each type of electronic devices. Therefore, in a case where the total number of pairings for the information processing apparatus is reached only by the number of pieces of pairing information of a specific type of electronic devices (for example, tablets), old pairing information of other types of electronic devices (for example, barcode scanners) may be deleted.

### SUMMARY

An information processing apparatus according to an aspect of the present disclosure is an information processing apparatus capable of establishing Bluetooth connection with each of a first electronic device belonging to a first type and a second electronic device belonging to a second type that is different from the first type, the information processing apparatus including: a storage section configured to store identification information of the first electronic device and identification information of the second electronic device; a determination section configured to determine that an electronic device in Bluetooth connection is the first electronic device or the second electronic device in a case where the Bluetooth connection has been established with the first electronic device or the second electronic device; and a storage management section configured to perform management such that in a case where the electronic device in the Bluetooth connection is determined to be the first electronic device, the storage management section stores the identification information of the first electronic device in the storage section, and in a case where a same number of pieces of identification information of other first electronic devices as a maximum number of pieces of savable identification information of first electronic devices have already been stored in the storage section, the storage management section deletes an oldest piece of identification information among the pieces of identification information of the other first electronic devices from the storage section, and such that in a case where the electronic device in the Bluetooth connection is determined to be the second electronic device, the storage management section stores the identification information of the second electronic device in the storage section, and in a case where a same number of pieces of identification information of other second electronic devices as a maximum number of pieces of savable identification information of second electronic devices have already been stored in the storage section, the storage management section deletes an oldest piece of identification information among the pieces of identification information of the other second electronic devices from the storage section.

An information processing method according to an aspect of the present disclosure is an information processing method executed by a computer that establishes Bluetooth connection with each of a first electronic device belonging to a first type and a second electronic device belonging to a second type that is different from the first type, the information processing method including: determining that an electronic device in Bluetooth connection is the first electronic device or the second electronic device in a case where the Bluetooth connection has been established with the first electronic device or the second electronic device; performing management of storing, in a case where the electronic device in the Bluetooth connection is determined to be the first electronic device, identification information of the first electronic device in a storage section of the computer, and deleting, in a case where a same number of pieces of identification information of other first electronic devices as a maximum number of pieces of savable identification information of first electronic devices have already been stored in the storage section, an oldest piece of identification information among the pieces of identification information of the other first electronic devices from the storage section; and performing management of storing, in a case where the electronic device in the Bluetooth connection is determined to be the second electronic device, identification information of the second electronic device in the storage section, and deleting, in a case where a same number of pieces of identification information of other second electronic devices as a maximum number of pieces of savable identification information of second electronic devices have already been stored in the storage section, an oldest piece of identification information among the pieces of identification information of the other second electronic devices from the storage section.

A non-transitory computer-readable storage medium storing a program according to an aspect of the present disclosure is a non-transitory computer-readable storage medium storing a program for causing a computer to execute an information processing method for establishing Bluetooth connection with each of a first electronic device belonging to a first type and a second electronic device belonging to a second type that is different from the first type, the information processing method including: determining that an electronic device in Bluetooth connection is the first electronic device or the second electronic device in a case where the Bluetooth connection has been established with the first electronic device or the second electronic device, performing management of storing, in a case where the electronic device in the Bluetooth connection is determined to be the first electronic device, identification information of the first electronic device in a storage section of the computer, and deleting, in a case where a same number of pieces of identification information of other first electronic devices as a maximum number of pieces of savable identification information of first electronic devices have already been stored in the storage section, an oldest piece of identification information among the pieces of identification information of the other first electronic devices from the storage section; and performing management of storing, in a case where the electronic device in the Bluetooth connection is determined to be the second electronic device, identification information of the second electronic device in the storage section, and deleting, in a case where a same number of pieces of identification information of other second electronic devices as a maximum number of pieces of savable identification information of second electronic devices have already been stored in the storage section, an oldest piece of identification information among the pieces of identification information of the other second electronic devices from the storage section.

### BRIEF DESCRIPTION OF THE DRAWINGS

FIG. 1 is a block diagram illustrating a configuration example of a communication system according to an embodiment.

FIG. 2 is a flowchart illustrating connection, determination, and storage management between an information processing apparatus and an electronic device.

FIG. 3 is a flowchart illustrating connection between the information processing apparatus and a first electronic device in detail.

FIG. 4 is a flowchart illustrating connection between the information processing apparatus and a second electronic device in detail.

FIG. 5 is a block diagram illustrating a configuration example of an information processing apparatus having no display section according to another embodiment.

### DESCRIPTION OF EMBODIMENTS

Hereinafter, an embodiment of the present disclosure will be described with reference to the drawings. Note that the drawings are merely examples for explaining the embodiment of the present disclosure. Furthermore, not all constituent elements described in the embodiment of the present disclosure are necessarily essential constituent elements in the present disclosure.

### Embodiment

### System Configuration Example

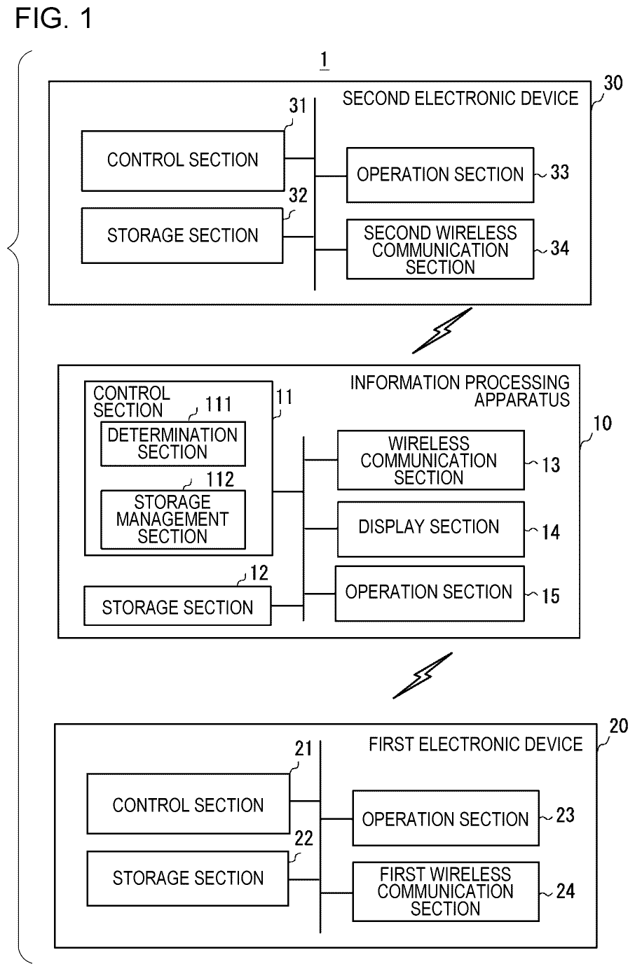

A communication system according to an embodiment will be described using FIG. 1. FIG. 1 is a block diagram illustrating a configuration example of the communication system according to the embodiment.

As illustrated in FIG. 1, a communication system 1 according to the present embodiment includes an information processing apparatus 10, at least one first electronic device 20, and at least one second electronic device 30. The first electronic device 20 is an electronic device of a first type and can be a tablet in this example. The second electronic device 30 is an electronic device of a second type, which is different from the first type, and can be a barcode reader in this example. In some embodiments, the electronic devices of the first type and the second type may be various electronic devices capable of establishing Bluetooth connection, such as smartphones, tablets, smart watches, earphones, mouses, keyboards, readers, and the like, which are of different types. In some embodiments, the electronic devices of the first type and the second type may be defined in accordance with different Bluetooth protocols. For example, the first electronic device of the first type may be of a personal area network (PAN), while the second electronic device of the second type may be of a human interface device (HID).

Hereinafter, schematic configuration examples of the information processing apparatus 10, the first electronic device 20, and the second electronic device 30 will be described in this order.

### Schematic Configuration Example of Information Processing Apparatus 10

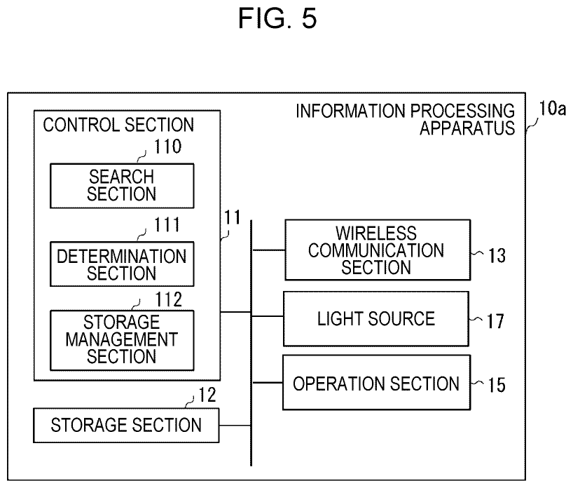

The information processing apparatus 10 is used to establish connection for Bluetooth communication with the first electronic device 20 or the second electronic device 30. The information processing apparatus 10 may be, for example, a concentrator (hereinafter, referred to as a HubBOX). In some embodiments, the information processing apparatus 10 can be an apparatus having a communication function, such as a smartphone, a tablet terminal, or a personal computer (PC). The information processing apparatus 10 is not limited to a portable apparatus and may be a stationary apparatus. As illustrated in FIG. 1, the information processing apparatus 10 can include a control section 11, a storage section 12, a wireless communication section 13, a display section 14, and an operation section 15. Note that in other embodiments, the information processing apparatus may not include a display section (see FIG. 5).

The control section 11 performs overall control of the information processing apparatus 10. The control section 11 includes, for example, an arithmetic processing unit such as a central processing unit (CPU) or a graphics processing unit (GPU), a working memory, and a storage device that stores a control program, parameters, and the like. The control section 11 can also be configured as a system on a chip (SoC). The control section 11 can be configured to store the control program in an executable state. However, the control section 11 can also be configured to store the control program as a circuit configuration such as a field-programmable gate array (FPGA) or can be configured as a dedicated circuit. The program can include a program for implementing functions of the information processing apparatus 10 in cooperation with the storage section 12, the wireless communication section 13, the display section 14, and the operation section 15. Although it is also possible for the control section 11 to include a communication control section that controls communication by the wireless communication section 13, description will be given on the assumption that control of the wireless communication section 13 is also performed by the control section 11 for simplifying the description.

The functions of the information processing apparatus 10 include a function of displaying a user interface (UI) image, which is an operation image used when connection for Bluetooth communication between the first electronic device 20 and the second electronic device 30 is established, on the display section 14. Displaying the UI image on the display section 14 may be displaying the UI image provided by the first electronic device 20 on a browser. Furthermore, the functions of the information processing apparatus 10 include, for example, a function of receiving a user operation on the UI image from the operation section 15.

The storage section 12 is, for example, a hard disk drive, a solid-state drive, or another memory. A portion of the memory included in the control section 11 may be regarded as the storage section 12. The storage section 12 can also be regarded as a portion of the control section 11.

The display section 14 is a component for displaying information. The display section 14 can display a UI image, which is an operation image provided by the first electronic device 20, as at least a portion of the information. The display section 14 is configured by, for example, a display device such as a liquid crystal display or an organic EL display. The display section 14 can also be configured to include a display and a drive circuit for driving the display. When the information processing apparatus 10 establishes Bluetooth connection with an electronic device, the information processing apparatus 10 can start searching and then display a list of responding electronic devices on the display section 14 of the information processing apparatus 10.

The operation section 15 is a component that receives an operation or an input by a user and can also be referred to as an operation receiving section. The operation section 15 can receive an operation on an operation image displayed on the display section 14. The operation section 15 can be implemented by, for example, any of a physical button, a touch panel or a touch sensor mounted on the display section 14, a pointing device, a keyboard, and the like. In a configuration in which the operation section 15 includes a touch panel or a touch sensor, the display section 14 and the touch panel can be collectively referred to as an operation panel of the information processing apparatus 10.

The wireless communication section 13 performs wireless communication with a first wireless communication section 24 of the first electronic device 20 or a second wireless communication section 34 of the second electronic device 30, which will be described later. The wireless communication section 13 can be a communication interface for the information processing apparatus 10 to wirelessly communicate with an external device in accordance with a communication protocol of a predetermined communication scheme. The wireless communication section 13 can include a plurality of wireless communication interfaces in accordance with different communication schemes. The predetermined communication scheme is a communication scheme in accordance with the Bluetooth standard. The version of the Bluetooth standard does not matter. Thus, the Bluetooth standard may be, for example, Bluetooth Low Energy. Hereinafter, wireless communication and connection thereof by the communication scheme in accordance with the Bluetooth standard will be referred to as BT communication and BT connection, respectively. The wireless communication section 13 performs wireless communication with the first electronic device 20 by a first communication scheme and with the second electronic device 30 by a second communication scheme. In the communication system 1, a case where the external device is a first electronic device 20 is included, and a case where the external device is another device can also be included.

### Schematic Configuration Example of First Electronic Device

Each first electronic device 20 is an electronic device belonging to the first type and can be one of various devices having a communication function, such as a smartphone, a tablet terminal, a PC, a printer, a handy terminal, an automatic change machine, a barcode reader, and a credit card payment terminal. This example will be described on the assumption that the first electronic device 20 is a tablet terminal (terminal device). The terminal device may be a tablet or a smartphone. Note that the first electronic device 20 is not limited to a portable device and may be a stationary device. As illustrated in FIG. 1, the first electronic device 20 can include a control section 21, a storage section 22, an operation section 23, and the first wireless communication section 24.

The control section 21 can also be referred to as a controller and performs overall control of the first electronic device 20. The control section 21 can be configured to include, for example, an arithmetic processing unit such as a CPU or a GPU, a working memory, and a storage device that stores a control program, parameters, and the like. The control section 21 can also be configured as a SoC. The control section 21 can be configured to store the control program in an executable state. However, the control section 21 can also be configured to store the control program as a circuit configuration such as a field-programmable gate array (FPGA) or can be configured as a dedicated circuit. The program can include a program for implementing functions of the first electronic device 20 in cooperation with the storage section 22, the operation section 23, and the first wireless communication section 24. Although it is also possible for the control section 21 to include a communication control section that controls communication by the first wireless communication section 24, description will be given on the assumption that the control of the first wireless communication section 24 is also performed by the control section 21 for simplifying the description.

The storage section 22 is, for example, a hard disk drive, a solid-state drive, or another memory. A portion of the memory included in the control section 21 may be regarded as the storage section 22. The storage section 22 can also be regarded as a portion of the control section 21.

The operation section 23 is a component that receives an operation or an input by a user and can also be referred to as an operation receiving section. The operation section 23 can be implemented by, for example, a physical button. Furthermore, the operation section 23 may be an operation section other than the physical button similarly to the operation section 15 of the information processing apparatus 10.

The first wireless communication section 24 performs wireless communication with the wireless communication section 13 of the information processing apparatus 10. The first wireless communication section 24 can be a communication interface for the first electronic device 20 to wirelessly communicate with an external device in accordance with the communication protocol of the first communication scheme. In this example, since the first electronic device 20 is a tablet terminal, the communication protocol of the first communication scheme is a personal area network (PAN).

Although not illustrated, the first electronic device 20 can also include a display section for displaying information similarly to the information processing apparatus 10. In addition, the display section and the operation section 23 of the first electronic device 20 can also configure an operation panel.

### Schematic Configuration Example of Second Electronic Device

Each second electronic device 30 is an electronic device belonging to the second type that is different from the first type and can be one of various devices having a communication function, such as a smartphone, a tablet terminal, a PC, a printer, a handy terminal, an automatic change machine, and a credit card payment machine. In this example, description will be given on the assumption that the second electronic device 30 is a barcode reader that is a type different from the type of the first electronic device 20, which is a tablet terminal. Note that the second electronic device 30 is not limited to a portable device and may be a stationary device. As illustrated as an example in FIG. 1, the second electronic device 30 can include a control section 31, a storage section 32, an operation section 33, and a second wireless communication section 34.

The control section 31 can also be referred to as a controller and performs overall control of the second electronic device 30. The control section 31 can be configured to include, for example, an arithmetic processing unit such as a CPU or a GPU, a working memory, and a storage device that stores a control program, parameters, and the like. The control section 31 can also be configured as a SoC. The control section 31 can be configured to store the control program in an executable state. However, the control section 31 can also be configured to store the control program as a circuit configuration such as a field-programmable gate array (FPGA) or can be configured as a dedicated circuit. The program can include a program for implementing functions of the second electronic device 30 in cooperation with the storage section 32, the operation section 33, and the second wireless communication section 34. Although it is also possible for the control section 31 to include a communication control section that controls communication by the second wireless communication section 34, description will be given on the assumption that control of the second wireless communication section 34 is also performed by the control section 31 for simplifying the description.

The storage section 32 is, for example, a hard disk drive, a solid-state drive, or another memory. A portion of the memory included in the control section 31 may be regarded as the storage section 32. The storage section 32 can also be regarded as a portion of the control section 31.

The operation section 33 is a component that receives an operation or an input by a user and can also be referred to as an operation receiving section. The operation section 33 can be implemented by, for example, a physical button. Furthermore, the operation section 33 may be an operation section other than the physical button similarly to the operation section 15 of the information processing apparatus 10.

The second wireless communication section 34 performs wireless communication with the wireless communication section 13 of the information processing apparatus 10. The second wireless communication section 34 can be a communication interface for the second electronic device 30 to wirelessly communicate with an external device in accordance with the communication protocol of the second communication scheme. In this example, since the second electronic device 30 is a barcode reader, the communication protocol of the second communication scheme is a human interface device (HID). In the communication system 1, a case where the external device is a second electronic device 30 is included, and a case where the external device is another device can also be included.

Although not illustrated, the second electronic device 30 can also include a display section for displaying information similarly to the information processing apparatus 10. In addition, the display section and the operation section 33 of the second electronic device 30 can also configure an operation panel.

Next, features of the information processing apparatus according to the present disclosure will be described in detail.

The information processing apparatus 10 may establish Bluetooth connection with each of the first electronic device 20 belonging to the first type and the second electronic device 30 belonging to the second type that is different from the first type. The information processing apparatus 10 includes the control section 11 and the storage section 12. The storage section 12 stores identification information of the first electronic device 20 and identification information of the second electronic device 30. The identification information of the first electronic device 20 and the second electronic device 30 is also referred to as pairing information and may be information by which each electronic device can be uniquely identified.

The control section 11 includes a determination section 111 and a storage management section 112. The control section has these functions of executing various kinds of control (that is, an information processing method) based on various programs stored in the storage section.

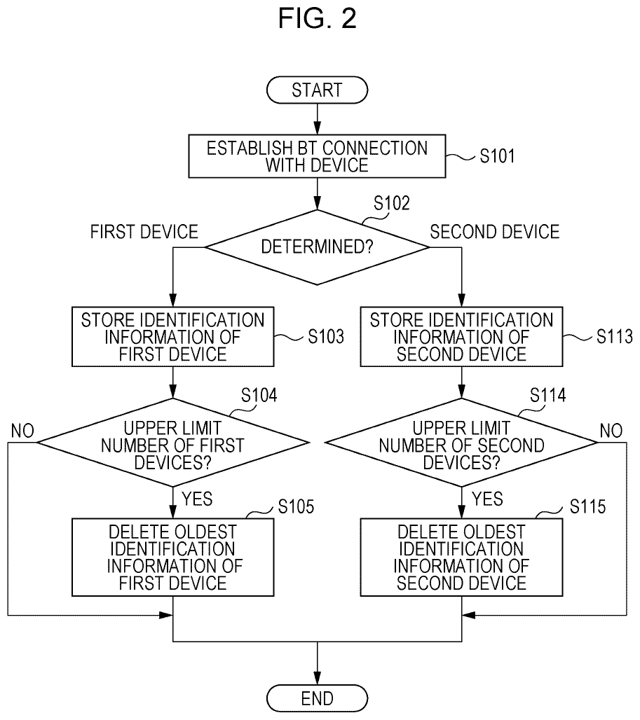

FIG. 2 is a flowchart illustrating connection, determination, and storage management between the information processing apparatus and an electronic device. In a case where Bluetooth connection has been established with the first electronic device 20 or the second electronic device 30 (S101), the determination section 111 determines that the electronic device is the first electronic device 20 (the tablet in this example) or the second electronic device 30 (the barcode reader in this example) (S102).

In a case where the determination section 111 determines that the electronic device in the Bluetooth connection is the first electronic device 20, the storage management section 112 stores the identification information of the first electronic device 20 in the storage section 12 (S103). At this time, management is performed such that in a case where the same number of pieces of identification information of other first electronic devices as the maximum number of pieces of savable identification information of first electronic devices 20 have already been stored in the storage section 12 (YES in S104), the oldest piece of identification information among those of the other first electronic devices is deleted from the storage section 12 (S105), and the identification information of the first electronic device 20 is stored in the storage section 12. The maximum number of pieces of savable identification information of first electronic devices is an upper limit number of pieces up to which identification information of first electronic devices belonging to the first type and allowing the information processing apparatus 10 to establish Bluetooth connection therewith can be saved. The storage section 12 may store the maximum number (upper limit threshold value) of pieces of savable identification information of first electronic devices.

Similarly, in a case where the determination section 111 determines that the electronic device in the Bluetooth connection is the second electronic device 30, the storage management section 112 stores the identification information of the second electronic device 30 in the storage section 12 (S113). At this time, management is performed such that in a case where the same number of pieces of identification information of other second electronic devices 30 as the maximum number of pieces of savable identification information of second electronic devices 30 have already been stored in the storage section 12 (YES in S114), the oldest piece of identification information among those of the other second electronic devices is deleted from the storage section 12 (S115), and the identification information of the second electronic device 30 is stored in the storage section 12. The maximum number of pieces of savable identification information of second electronic devices is an upper limit number of pieces up to which identification information of second electronic devices belonging to the second type and allowing the information processing apparatus 10 to establish Bluetooth connection therewith can be saved. The storage section 12 may store the maximum number (upper limit threshold value) of pieces of identification information of second electronic devices.

In other words, the storage management section 112 can separately store and manage the identification information of at least one first electronic device and the identification information of at least one second electronic device. In this manner, even in a case where the total number of pairings of the information processing apparatus is reached only by the number of pieces of pairing information of electronic devices of a specific type (for example, tablets), pairing information of electronic devices of another type (for example, barcode scanners) can be held.

In some embodiments, the determination section 111 can determine the first electronic device and the second electronic device based on information at the time of connection. For example, the first electronic device 20 belonging to the first type may be able to establish Bluetooth connection with the information processing apparatus 10 by a first communication protocol. Also, the second electronic device 30 belonging to the second type may be able to establish Bluetooth connection with the information processing apparatus 10 in accordance with a second communication protocol that is different from the first communication protocol. In this case, in a case where Bluetooth connection has been established with the first electronic device 20 or the second electronic device 30, the determination section 111 may determine that the electronic device is the first electronic device 20 or the second electronic device 30 in accordance with the communication protocol of Bluetooth.

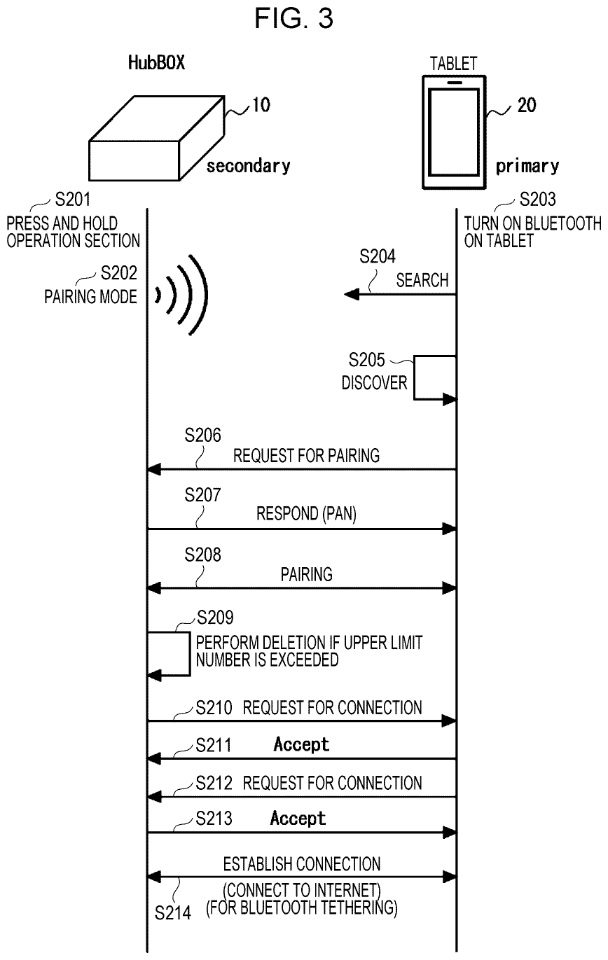

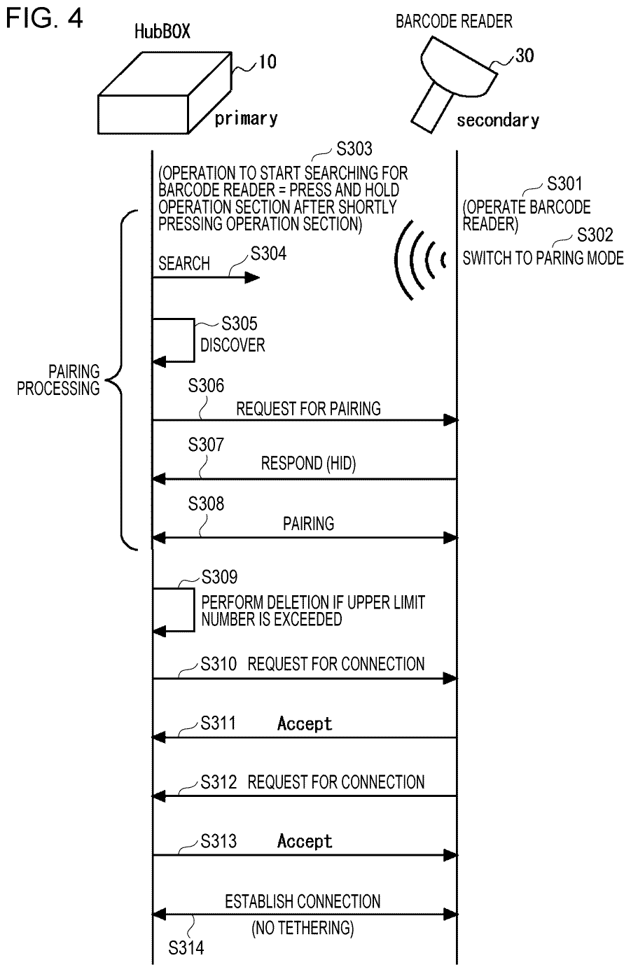

In other embodiments, the determination section 111 can determine the first electronic device 20 and the second electronic device 30 based on a difference in a connection method. The difference in the connection method is a difference between whether the information processing apparatus 10 is on the side to be searched for by the electronic device (see FIG. 3) or whether the information processing apparatus 10 is on the side to search for the electronic device (see FIG. 4) although details will be described later.

FIG. 3 is a flowchart illustrating connection between the information processing apparatus and the first electronic device in detail. When Bluetooth connection is established between the information processing apparatus 10 and the first electronic device 20, the information processing apparatus 10 as a secondary element is on the side to be searched for by the first electronic device 20 as a primary element, and the connection is established by the following PAN connection procedure. In this example, the information processing apparatus 10 is a HubBOX, and the first electronic device 20 is a tablet.

First, an operation of starting searching for the first electronic device, such as a user's operation of pressing and holding the operation section 15 (FIG. 1), is performed on the HubBOX (S201). The HubBOX then enters a pairing mode (S202). Once the user turns on Bluetooth of the tablet (S203), then the tablet starts searching (S204). The tablet discovers the HubBOX in the pairing mode (S205). Thereafter, the tablet transmits a pairing request to the HubBOX (S206). The HubBOX responds to the pairing request from the tablet (S207). As a result, PAN connection is performed, and pairing between the HubBOX and the tablet is established (S208).

Since information regarding communication with the connection destination indicates the PAN connection, the determination section 111 of the control section 11 of the information processing apparatus 10 (HubBOX) can determine that the electronic device is the tablet, which is the first electronic device 20. The storage management section 112 stores identification information of the tablet, which is the first electronic device 20, as a pairing ID in the storage section 12. In this example, the upper limit number of first electronic devices (PAN devices) that can be saved in the storage section 12 is eight.

In a case where the number of pieces of identification information of tablets stored in the storage section 12 exceeds the upper limit number, the storage management section 112 deletes the oldest piece of identification information among those of other first electronic devices (PAN device) (S209). The HubBOX transmits a connection request to the tablet (S210). The tablet accepts the connection request (S211). The tablet transmits a connection request to the HubBOX (S212). Also, the HubBOX accepts the connection request (S213). Note that although any of the primary element and the secondary element may transmit the connection request earlier, they transmit the connection request to each other.

In this manner, the connection between the HubBOX, which is the information processing apparatus 10, and the tablet, which is the first electronic device (PAN device), is established (S214). Thus, the tablet can be connected to the Internet via the HubBOX. In other words, the tablet is intended to perform Bluetooth tethering through the connection.

FIG. 4 is a flowchart illustrating the connection between the information processing apparatus and the second electronic device in detail. When Bluetooth connection is established between the information processing apparatus 10 and the second electronic device 30, the information processing apparatus 10 as a primary element is on the side to search for the second electronic device 30 as a secondary element, and the connection is performed by the following HID connection procedure. In this example, the information processing apparatus 10 is a HubBOX, and the second electronic device 30 is a barcode reader.

First, the barcode reader is operated (S301), and the barcode reader then enters the pairing mode (S302). Next, the operation section of the HubBOX is operated by the user. In other words, an operation to start searching for the second electronic device by shortly pressing the operation section 15 (FIG. 1) and then pressing and holding the operation section 15 is performed (S303). Then, the HubBOX starts searching (S304). The HubBOX discovers the barcode reader in the pairing mode (S305). Thereafter, the HubBOX transmits a pairing request to the barcode reader (S306). The barcode reader responds to the pairing request from the HubBOX (S307). In this manner, HID connection is performed, and pairing between the HubBOX and the barcode reader is established (S308).

Since information regarding communication with the connection destination indicates HID connection, the determination section 111 of the control section 11 of the information processing apparatus 10 (HubBOX) can determine that the electronic device is the barcode reader, which is the second electronic device 30. The storage management section 112 stores identification information of the barcode reader, which is the second electronic device 30, as a pairing ID in the storage section 12. Note that in this example, the upper limit number of second electronic devices (HID devices) that can be saved in the storage section 12 is one.

In a case where the number of pieces of identification information of tablets stored in the storage section 12 exceeds the upper limit number, the storage management section 112 deletes the oldest piece of identification information among those of other second electronic devices (HID devices) (S309). The HubBOX transmits a connection request to the barcode reader (S310). The barcode reader accepts the connection request (S311). The barcode reader transmits a connection request to the HubBOX (S312). Furthermore, the barcode reader accepts the connection request (S313). Note that although any of the primary element and the secondary element may transmit the connection request earlier, they transmit the connection request to each other.

In this manner, connection between the HubBOX, which is the information processing apparatus 10, and the barcode reader, which is the second electronic device (HID device), is established (S314). Unlike the case of FIG. 3, the barcode reader does not perform Bluetooth tethering through the connection.

As described above, the determination section 111 of the control section 11 of the information processing apparatus 10 can determine that the electronic device is the first electronic device or the second electronic device in accordance with whether the information processing apparatus 10 is on the side to be searched for by the electronic device (first electronic device) (see FIG. 3) or whether the information processing apparatus 10 is on the side to search for the electronic device (second electronic device) (see FIG. 4). In addition, the determination section 111 can also determine that the electronic device is the first electronic device or the second electronic device in accordance with the method by which the user operates the operation section 15 (for example, only pressing and holding the operation section 15, or pressing and holding the operation section 15 after shortly pressing the operation section 15).

Here, the storage management operation will be specifically described.

In a case where the number of first electronic devices 20 that can be paired (maximum number of savable devices) is defined as X and the number of second electronic devices 30 that can be paired (maximum number of savable devices) is defined as Y, the number of electronic devices that can be paired with the information processing apparatus 10 (total number of storable apparatuses) can be set to X+Y+1. In other words, it is possible to perform the following storage management operation by increasing the number of electronic devices that can be paired with the information processing apparatus 10 (total number of storable apparatuses) by one from the sum of the numbers of first electronic devices 20 and the second electronic devices 30 that can be paired. In other words, in a case where the first electronic device is newly connected in a state where the maximum number of first electronic devices and the maximum number of second electronic devices are both connected, X+Y+1 pieces of identification information are temporarily stored, and the oldest piece of identification information of one first electronic device is then immediately deleted. In other words, the total number of pieces of identification information of the first electronic devices and the second electronic devices becomes X+Y.

Specifically, in a case where the first electronic device is Bluetooth-connected to the information processing apparatus, the storage management section 112 checks the number of pieces of identification information of first electronic devices among the pieces of saved identification information. If the number of pieces of stored identification information of first electronic devices including the newly connected device is X+1, the oldest piece of identification information among those of the first electronic devices is deleted. As a result, the total number of pieces of identification information of first electronic devices becomes X.

In a case where the second electronic device is Bluetooth-connected to the information processing apparatus, the storage management section 112 checks the number of pieces of identification information of second electronic devices among the pieces of saved information. If the number of pieces of stored identification information of the second electronic devices including the newly connected device is Y+1, the oldest piece of identification information among those of the second electronic devices is deleted. As a result, the total number of pieces of stored identification information of second electronic devices becomes Y.

Next, automatic connection of an information processing apparatus having no screen display will be described.

FIG. 5 is a block diagram illustrating a configuration example of an information processing apparatus having no display section according to another embodiment. An information processing apparatus 10a illustrated in FIG. 5 includes a light source 17 added instead of the display section 14. The light source 17 may be, for example, a light emitting diode (LED) but is not limited thereto. Also, a control section 11 additionally includes a search section 110.

Typically, as illustrated in FIG. 1, when the information processing apparatus 10 connects to an electronic device such as a barcode scanner, the information processing apparatus 10 starts searching and then displays a list of electronic devices that have responded on the display section 14 (FIG. 1) of the information processing apparatus 10. Pairing with an electronic device selected by the user from the screen is then started. However, this method cannot be adopted by the information processing apparatus 10a (FIG. 5) having no screen for displaying the search result.

Therefore, as a method by which the information processing apparatus 10a having no display screen connects to such a second electronic device 30, the search section 110 of the information processing apparatus 10a starts searching, and data such as identification information of the electronic devices that have responded is then analyzed. As a result, in a case where an electronic device matching the information corresponding to an intention of connection (for example, attribute information corresponding to an intention of connection) is discovered, pairing with the second electronic device 30 is automatically started without a user's selecting operation.

Note that in a case where a plurality of electronic devices matching the information corresponding to the intention of connection (for example, attribute information corresponding to the intention of connection) are discovered, 1. connecting to an electronic device that has responded earliest, 2. connecting to an electronic device having the strongest signal, 3. not establishing connection (that is, retrying the search), and the like are conceivable. In some embodiments, the search section 110 may stop the search processing in a case where a plurality of first electronic devices 20 are discovered.

In the information processing apparatus having no screen display, connection states of different types of Bluetooth devices can be expressed by states of the light source 17. In other words, the light source can be “turned off” in a case where no electronic devices are connected, the light source can be “turned on” during pairing, and the light source can be “turned on” in a connected state.

In addition, whether the pairing processing with the first electronic device 20 or the pairing processing with the second electronic device 30 is being carried out may be able to be distinguished by changing lighting patterns (that is, using different lighting cycles) between during the pairing with the first electronic device 20 and during the pairing with the second electronic device 30.

In some embodiments, the light source 17 may be brought into a blinking state in a case where the search section 110 is searching for at least one of the first electronic device 20 and the second electronic device 30, while the light source 17 may be brought into a turned-on state in a case where Bluetooth connection with at least one of the first electronic device and the second electronic device has been established.

Colors (for example, red, blue, and yellow) of the LEDs at the time of lighting may be changed in three patterns, namely in a state where connection to the first electronic device 20 has been established, in a state where connection to the second electronic device 30 has been established, and in a state where connection to both the electronic devices 20 and 30 has been established.

In addition, the above-described program includes an instruction group (or a software code) for causing a computer to perform one or more functions described in the embodiment in a case where the program is read by the computer. The program may be stored in a non-transitory computer-readable medium or a tangible storage medium. By way of non-limiting examples, examples of the computer-readable medium or the tangible storage medium include a random-access memory (RAM), a read-only memory (ROM), a flash memory, a solid-state drive (SSD), and other memory technologies. Also, by way of non-limiting examples, examples of the computer-readable medium or the tangible storage medium include a CD-ROM, a digital versatile disc (DVD), a Blu-ray (registered trademark) disc, and other optical disc storages, a magnetic cassette, a magnetic tape, a magnetic disk storage, and other magnetic storage devices. The program may be transmitted on a transitory computer-readable medium or a communication medium. By way of non-limiting examples, the transitory computer-readable medium or the communication medium includes propagating signals in electrical, optical, acoustic, and other forms.

Although the present disclosure has been described with reference to the above-described embodiments, the present disclosure is not limited only to the configurations described in the above-described embodiments, and it goes without saying that the present disclosure includes various modifications, corrections, and combinations that can be made by those skilled in the art within the scope of the claims of the present application.

What is claimed is:

1. An information processing apparatus capable of establishing Bluetooth connection with each of a first electronic device belonging to a first type and a second electronic device belonging to a second type that is different from the first type, the information processing apparatus comprising:
a storage section configured to store identification information of the first electronic device and identification information of the second electronic device;
a determination section configured to determine that an electronic device in Bluetooth connection is the first electronic device or the second electronic device in a case where the Bluetooth connection has been established with the first electronic device or the second electronic device; and
a storage management section configured to
perform management such that in a case where the electronic device in the Bluetooth connection is determined to be the first electronic device, the storage management section stores the identification information of the first electronic device in the storage section, and in a case where a same number of pieces of identification information of other first electronic devices as a maximum number of pieces of savable identification information of first electronic devices have already been stored in the storage section, the storage management section deletes an oldest piece of identification information among the pieces of identification information of the other first electronic devices from the storage section, and
perform management such that in a case where the electronic device in the Bluetooth connection is determined to be the second electronic device, the storage management section stores the identification information of the second electronic device in the storage section, and in a case where a same number of pieces of identification information of other second electronic devices as a maximum number of pieces of savable identification information of second electronic devices have already been stored in the storage section, the storage management section deletes an oldest piece of identification information among the pieces of identification information of the other second electronic devices from the storage section.

2. The information processing apparatus according to claim 1, wherein
the first electronic device belonging to the first type is Bluetooth-connectable to the information processing apparatus by a first communication protocol,
the second electronic device belonging to the second type is Bluetooth-connectable to the information processing apparatus by a second communication protocol that is different from the first communication protocol, and
the determination section determines, in a case where Bluetooth connection has been established with the first electronic device or the second electronic device, that the electronic device in the Bluetooth connection is the first electronic device or the second electronic device in accordance with a communication protocol of Bluetooth.

3. The information processing apparatus according to claim 1, further comprising
an operation section configured to be operated by a user, wherein
the determination section determines that the electronic device in the Bluetooth connection is the first electronic device or the second electronic device in accordance with an operation method of the user on the operation section.

4. The information processing apparatus according to claim 1, further comprising
a search section configured to search for a Bluetooth-connectable electronic device, wherein
the determination section determines that the electronic device in the Bluetooth connection is the first electronic device or the second electronic device in accordance with whether the search section of the information processing apparatus searches for the electronic device or whether the information processing apparatus is searched for by the electronic device.

5. The information processing apparatus according to claim 1, further comprising
a search section configured to search for a Bluetooth-connectable electronic device, wherein
the search section stops search processing in a case where a plurality of first electronic devices are discovered.

6. The information processing apparatus according to claim 1, further comprising
a search section configured to search for a Bluetooth-connectable electronic device, wherein
in a case where the Bluetooth connection has been established with the first electronic device, the search section does not execute searching if an operation of starting searching for the first electronic device has been executed, and
in a case where the Bluetooth connection has been established with the second electronic device, the search section executes the searching if the operation of starting searching for the first electronic device has been executed.

7. The information processing apparatus according to claim 1, further comprising:
a search section configured to search for a Bluetooth-connectable electronic device; and
a light source, wherein
in a case where the search section is searching for at least one of the first electronic device and the second electronic device, the light source is brought into a blinking state, and
in a case where the Bluetooth connection with at least one of the first electronic device and the second electronic device has been established, the light source is brought into a turned-on state.

8. The information processing apparatus according to claim 1, wherein the first electronic device is a terminal device, and the second electronic device is a barcode reader.

9. An information processing method executed by a computer that establishes Bluetooth connection with each of a first electronic device belonging to a first type and a second electronic device belonging to a second type that is different from the first type, the information processing method comprising;
determining that an electronic device in Bluetooth connection is the first electronic device or the second electronic device in a case where the Bluetooth connection has been established with the first electronic device or the second electronic device;
performing management of storing, in a case where the electronic device in the Bluetooth connection is determined to be the first electronic device, identification information of the first electronic device in a storage section of the computer, and deleting, in a case where a same number of pieces of identification information of other first electronic devices as a maximum number of pieces of savable identification information of first electronic devices have already been stored in the storage section, an oldest piece of identification information among the pieces of identification information of the other first electronic devices from the storage section; and
performing management of storing, in a case where the electronic device in the Bluetooth connection is determined to be the second electronic device, identification information of the second electronic device in the storage section, and deleting, in a case where a same number of pieces of identification information of other second electronic devices as a maximum number of pieces of savable identification information of second electronic devices have already been stored in the storage section, an oldest piece of identification information among the pieces of identification information of the other second electronic devices from the storage section.

10. A non-transitory computer-readable storage medium storing a program for causing a computer to execute an information processing method for establishing Bluetooth connection with each of a first electronic device belonging to a first type and a second electronic device belonging to a second type that is different from the first type, the information processing method comprising:
determining that an electronic device in Bluetooth connection is the first electronic device or the second electronic device in a case where the Bluetooth connection has been established with the first electronic device or the second electronic device,
performing management of storing, in a case where the electronic device in the Bluetooth connection is determined to be the first electronic device, identification information of the first electronic device in a storage section of the computer, and deleting, in a case where a same number of pieces of identification information of other first electronic devices as a maximum number of pieces of savable identification information of first electronic devices have already been stored in the storage section, an oldest piece of identification information among the pieces of identification information of the other first electronic devices from the storage section; and
performing management of storing, in a case where the electronic device in the Bluetooth connection is determined to be the second electronic device, identification information of the second electronic device in the storage section, and deleting, in a case where a same number of pieces of identification information of other second electronic devices as a maximum number of pieces of savable identification information of second electronic devices have already been stored in the storage section, an oldest piece of identification information among the pieces of identification information of the other second electronic devices from the storage section.
